(19) United States
(12) Patent Application Publication
(10) Pub. No.: US 2015/0360238 A1
(43) Pub. Date: Dec. 17, 2015

(54) CONDITIONING OF THE ORE IN THE COMMINUTION STEP AND RECOVERY OF DESIRED METAL VALUES BY FLOTATION

(71) Applicants: PLATREEF RESOURCES PROPRIETARY LIMITED, Johannesburg (ZA); JAPAN OIL, GAS AND METALS NATIONAL CORPORATION, Minato-ku, Tokyo (JP)

(72) Inventors: Stephen Ralph Amos, Johannesburg (ZA); Iichi Nakamura, Tokyo (JP); Dominique Lascelles, Mississauga (CA)

(73) Assignees: JAPAN OIL, GAS AND METALS NATIONAL CORPORATION, Tokyo (JP); PLATREEF RESOURCES PROPRIETARY LIMITED, Johannesburg (ZA)

(21) Appl. No.: 14/654,473

(22) PCT Filed: Dec. 23, 2013
(86) PCT No.: PCT/IB2013/061277

§ 371 Date: Jun. 19, 2015

(30) Foreign Application Priority Data
Dec. 21, 2012 (ZA) 2012/09761

(51) Int. Cl. B03D 1/02; B03D 1/012; B03D 1/01; B03D 1/008

(52) U.S. Cl. CPC B03D 1/02; B03D 1/008; B03D 1/012; B03D 1/01

(57) ABSTRACT

The invention provides method to recover, by means of froth flotation, a desired metal value from a feedstock containing it. In a comminution step, the feedstock is comminuted using comminuting media of an iron and chrome steel alloy comprising from 12% to 30% chrome. In a conditioning step, the feedstock material is contacted with thiourea and/or oxalic acid as primary flotation reagents. The conditioning step comprises the comminution step, in which a quantity of the primary flotation reagent/s being added and preconditioned comminuted feedstock material being obtained. The conditioning step also comprises an optional conditioning finishing step, in which a mixture of the preconditioned comminuted feedstock material and a liquid is subjected to stirring and with conditioned comminuted feedstock material being obtained from the finishing step. In a recovery step, at least some of the desired metal value is recovered by froth flotation from the preconditioned or conditioned feedstock.

### FIELD OF THE INVENTION

THIS INVENTION relates to the recovery of desired metal values, containing desired metals, from materials containing such desired metal values. More particularly, the invention relates to the recovery of such desired metal values by means of froth flotation. The invention provides a method to recover, by means of froth flotation, a desired metal value, containing a desired metal, from a feedstock containing the desired metal value. The invention also provides a process to implement the method.

### BACKGROUND TO THE INVENTION

IN THE MAJORITY OF PLATINUM GROUP METAL (PGM) DEPOSITS, in South Africa in particular, the bulk of the PGMs are associated with base metal sulphides. The PGMs associated with such base metal sulphides are generally coarse grained and exhibit fast floating behaviour in froth flotation recovery operations. Advantageously, this usually results in high PGM recoveries.

The Applicant has found, however, that in certain deposits, and particularly in the PGM-rich so-called Platreef deposit in South Africa, a low level of the PGMs occur in the form of such a base metal sulphide association. Instead, the majority of PGMs in such deposits exist as amphoteric minerals, such as PGM arsenides, tellurides, bismuthides and antimonides. This phenomenon is not limited to the Platreef deposit.

Amphoteric PGM minerals are notoriously slow floating and occur in small grained from (<8 micron), making such PGM minerals difficult to recover effectively and economically. In order to recover, by froth flotation, such fine-grained PGM minerals, conventional wisdom would suggest that the mined ore must at least be milled very finely, even down to the typical PGM mineral grain size of <8 micron, thereby to expose as much of the PGM mineral as possible to a flotation environment for selection thereof to a floated froth product, or concentrate, to be effected. On a commercial scale, effecting such milling is, however, obstructed by economic considerations which, in turn, exacerbate the practical difficulties in recovering PGMs that exist as amphoteric minerals.

In wishing to recover desired metals in desired metal values that occur as amphoteric minerals in a fine grain form, the Applicant has accordingly identified a need to allow such minerals to be recovered economically by addressing particularly the slow floating characteristics of these minerals and the necessity for fine milling of feedstock containing the minerals. With the present invention, the Applicant seeks to address this need. On a broader horizon, the Applicant also seeks to address, generally, similar difficulties that may be encountered when seeking to recover metals other than PGMs when they exist in fine-grained form as amphoteric minerals.

### SUMMARY OF THE INVENTION

IN ACCORDANCE WITH ONE ASPECT OF THE INVENTION, there is provided a method to recover, by means of froth flotation, a desired metal value, containing a desired metal, from a feedstock material containing the desired metal value, the method including
in a comminution step, comminuting the feedstock material using comminuting media of an iron and chrome steel alloy comprising from 12% to 30% chrome;
in a conditioning step, conditioning the feedstock material for froth flotation recovery of the desired metal value by contacting the feedstock material with thiourea and/or oxalic acid as primary flotation reagent/s,
   wherein the conditioning step comprises
the comminution step, with a first quantity of primary flotation reagent/s being added to the feedstock material prior to or during the comminution step and with preconditioned comminuted feedstock material being obtained from the comminution step; and
an optional conditioning finishing step, in which a mixture of the preconditioned comminuted feedstock material and a liquid is subjected to stirring, with a second quantity of the primary flotation reagent/s optionally being added to the preconditioned comminuted feedstock material prior to or during the finishing step and with conditioned comminuted feedstock material being obtained from the finishing step,
   the method further including
in a recovery step, recovering by froth flotation at least some of the desired metal value from the preconditioned comminuted feedstock or, when the finishing step is conducted, from the conditioned comminuted feedstock, to a floated froth product, or concentrate.

In this specification, the term ‘desired metal value’ should be understood as referring to a mineral form of a desired metal that is desired to be recovered. In the context of the present invention, the mineral may, in particular, be an amphoteric mineral. The metal may, in particular, be a PGM.

The feedstock material would be a solid feedstock material, typically being rendered during, or already ahead of, the comminution step into slurry format, as is also described below. A typical feedstock material would be mined ore, but other feedstock materials containing desired metal values, particularly desired metal-containing amphoteric minerals, could also be used. Generally, any feedstock material would comprise the desired metal value and gangue in which the desired metal value is dispersed. After comminution in the comminution step, the feedstock material would typically comprise (i) possibly, but rarely in the context of fine-grained amphoteric minerals, comminuted particles comprising only the desired metal value, (ii) comminuted particles comprising the desired metal value and gangue, and (iii) comminuted particles comprising only gangue. Naturally, of these particles it is (i) and (ii) that are desired to be recovered to the concentrate. These particles are hereinafter referred to as ‘desired metal value-containing particles’ or ‘particles containing the desired metal value’.

It will be appreciated that, in the context of the conditioning step, the comminution step may be regarded as a preconditioning step, particularly when the conditioning finishing step is carried out. This does not mean, however, that reference hereinafter to the comminution step as a preconditioning step supposes that the optional conditioning finishing step is carried out.

Preferably, the optional conditioning finishing step is carried out. Although the second, optional quantity of primary flotation reagent/s may be added in this step, it is preferred that this option is not exercised and that primary flotation reagent/s is/are therefore not added during the conditioning finishing step, with the conditioning finishing step therefore comprising mixing of the preconditioned feedstock and the liquid in the absence of any additional primary flotation reagent/s to that which was added in the comminution step.

The conditioning step may be effected for a conditioning period that is from about 35 minutes to about 75 minutes in length. Preferably, the comminution step is effected for a comminution period that is from about 5 minutes to about 15 minutes in length and the conditioning finishing step is effected for a finishing period that is from about 30 minutes to about 60 minutes in length, with both the comminution and finishing periods running concurrently with, and therefore making up, the conditioning period. It will be appreciated that if the optional conditioning finishing step is omitted, the comminution step would occupy the entire length of the conditioning step.

The comminution media may, more specifically, comprise from about 14%, and more particularly from about 16%, to about 18% chrome. In specific, preferred embodiments, the comminution media may comprise 14%, 16% or 18% chrome. All of these percentages, in the context of the comminution media at least, are by mass. The comminution media may, in particular, be grinding and/or milling media, with the comminution step comprising a grinding and/or milling operation in which the feedstock material is subjected to grinding and/or milling with the grinding and/or milling media.

As also stipulated hereinafter, the comminution step is preferably carried out to obtain a≦75 micron particle size fraction of the feedstock material for use in the recovery step. Preferably, this particle size fraction has a mean particle size of 75 micron. The particle size fraction to be used in the recovery step could, however, in other embodiments have a mean particle size of between about 53 micron and about 150 micron.

As has been alluded to above, the feedstock material may be comminuted in the comminution step as a slurry. Accordingly, the preconditioned feedstock material that is obtained from the comminution step may also be in the form of a slurry. Preferably, the slurry containing the preconditioned feedstock material has a solids concentration of about 75%.

In the conditioning finishing step, when effected, the mixture of the preconditioned feedstock material and the liquid that is subjected to stirring may have a solids concentration, comprising the preconditioned feedstock material, of about 60%. The method may therefore, in an embodiment in which the preconditioned feedstock material is present in a slurry, include diluting the slurry containing the preconditioned feedstock material, that is obtained from the comminution step, with the liquid. The liquid is preferably water.

The first quantity of primary flotation reagents may comprise oxalic acid in an amount of about 200 grams per tonne of dry feedstock material and/or thiourea in an amount of about 50 grams per tonne of dry feedstock material. Preferably, both thiourea and oxalic acid are added.

As mentioned above, the feedstock material may be comminuted to obtain, for use in the recovery step, a 75 micron preconditioned or conditioned feedstock material particle size fraction, preferably having a mean particle size of 75 micron. The particle size fraction to be used in the recovery step could, however, in other embodiments have a mean particle size of between about 53 micron and about 150 micron. Naturally, it is possible that oversize particles may be present in the preconditioned and/or the conditioned feedstock material. The method may therefore include a size classification step ahead of the recovery step, in which the preconditioned or conditioned feedstock material is subjected to particle size-based classification with a 75 micron particle size fraction being recovered and used in the recovery step and a 75 micron particle size fraction being discarded and, preferably but optionally, re-used in the comminution step. The method may therefore include recycling oversize preconditioned and/or conditioned feedstock to the comminution stage.

The recovery step may comprise at least one froth flotation operation in which the preconditioned or conditioned feedstock material, preferably the 75 micron particle size fraction thereof, is subjected to froth flotation to recover, through such froth flotation, at least some of the desired metal value-containing particles contained in the preconditioned or conditioned feedstock material to the concentrate, thereby also obtaining residual tailings depleted of the recovered particles. Of course, it will be appreciated that when not all of the particles containing the desired metal value are recovered to the concentrate, residual desired metal value-containing particles will remain in the tailings, rendering the tailings suitable to be subjected to further froth flotation operations to maximise overall recovery of such particles and therefore also of the desired metal value.

Effecting froth flotation of the particles containing the desired metal value, generally speaking in the context of the invention, would typically include forming a slurry of the material that is to be subjected to froth flotation. The slurry that is subjected to froth flotation is generally referred to as a “pulp” in the art of the invention and this term will hereinafter from time to time be employed in the specification generically with reference to the material that is being subjected to froth flotation in any of the described froth flotation operations. As will be appreciated from the description that follows, such material would include the preconditioned or conditioned feedstock material, the concentrate of any froth flotation operation that is subjected to a further froth flotation operation, and/or the tailings of any froth flotation operation that is subjected to a further froth flotation operation. Effecting froth flotation would further include admixing secondary flotation reagents with the preconditioned or conditioned feedstock and passing a gas through the slurry to form the floated froth product, or concentrate, containing at least some of the particles containing the desired metal value, and residual tailings. The secondary flotation reagents would therefore be selected to promote flotation of the particles containing the desired metal value and therefore their recovery to the concentrate of the particular flotation operation.

The secondary flotation reagents may include desired metal value collectors, gangue depressants, frothers, co-collectors, and/or viscosity modifiers. These secondary flotation reagents would be selectable through routine experimentation by persons skilled in the art to achieve flotation of particles containing the desired metal value contained in the preconditioned or conditioned feedstock material. Preferred forms of such secondary flotation reagents, in the context of recovering platinum group metals as the desired metal, are, nonetheless, discussed below.

The collector may be a collector that is selective for the desired metal value to impart hydrophobicity thereon. In one form, the collector may be a xanthate or dithiocarbonate. In such a case, the collector may, in particular, be sodium isopropyl xanthate (SIPX). Any other suitable collector may, however, be used. By ‘suitable’ is meant any collector that is selective for the desired metal value, or rather for the particles containing the desired metal value, to impart hydrophobic qualities thereon in order to allow these particles to be floated and recovered to the concentrate.

The gangue depressant may be organic, being for example carboxymethyl cellulose (CMC).

The frother may, for example, be HP700, which is an alcohol in amine oxide frother.

The co-collector may, for example, be flotation reagent 3477, which is a dithiophosphate collector.

The method may include, in the recovery step, separately recovering, by means of froth flotation, high grade, medium grade and low grade desired metal value-containing particles from the preconditioned or conditioned feedstock material. By ‘high grade’, ‘medium grade’ and ‘low grade’, in this sense, there is referred to the relative desired metal value contents of the desired metal value-containing particles contained in the preconditioned or conditioned feedstock material, particularly in the particle size fraction that is being subjected to froth flotation in the recovery step. For a particular particle size fraction, high grade particles would have a higher content of the desired metal value than medium grade particles, while medium grade particles, in turn, would have a higher content of the desired metal value than low grade particles. For any discrete body of feedstock material, high, medium and low grade particles would therefore be discernible, provided that there are indeed discernible differences in the desired metal value contents of the desired metal value-containing particles contained in the feedstock material. The grade classification of a desired metal value-containing particle is reflected in its flotation behaviour, with high grade particles floating faster than medium grade particles, while medium grade particles, in turn, float faster than low grade particles, this holding true when using secondary flotation reactants suitable for flotation of the particular desired metal value.

In separately recovering high, medium and low grade metal value particles, the method may include
in a high grade recovery step, recovering, as a high grade concentrate, high grade preconditioned or conditioned desired metal value-containing particles;
in a separate and following medium grade recovery step, recovering, as a medium grade concentrate, medium grade preconditioned or conditioned desired metal value-containing particles from tailings of the high grade recovery step; and
in a separate and following low grade recovery step, recovering, as a low grade concentrate, low grade preconditioned or conditioned desired metal value-containing particles from tailings of the medium grade recovery step.

As has been suggested above, the high grade preconditioned or conditioned feedstock material would comprise mainly those desired metal value-containing particles that can be classified as being of a high grade in the context of the particular feedstock that is being subjected to froth flotation. Similarly, the medium grade preconditioned or conditioned feedstock material would comprise mainly those desired metal value-containing particles that can be classified as being of a medium grade in the context of the particular feedstock that is being subjected to froth flotation and the low grade preconditioned or conditioned feedstock material would comprise mainly those desired metal value-containing particles that can be classified as being of a low grade in the context of the particular feedstock that is being subjected to froth flotation.

The high, medium and low grade recovery steps may be distinguished on the basis of pulp residence time, with the high grade recovery step being associated with a short high grade recovery step residence time, the medium grade recovery step being associated with a longer medium grade recovery step residence time, and the low grade recovery step being associated with an even longer low grade recovery step residence time. In one embodiment of the invention, the high, medium and low grade recovery steps may implement so-called “roughing” froth flotation recovery operations.

The method may also include refining, separately in separate refining steps, each of the high grade concentrate, medium grade concentrate and low grade concentrate. Alternatively, the method may include refining the high grade product concentrate, medium grade product concentrate and low grade product concentrate together as a combined concentrate. By ‘refining’ is meant treating the respective high grade, medium grade and low grade concentrates or the combined concentrate in one or more further froth flotation operations to recover purer concentrates containing progressively lesser proportions of undesirable materials, or gangue. Such refining froth flotation operations may therefore reject a greater proportion of gangue in selecting particles for the concentrates thereof than in the case of the high grade, medium grade and low grade recovery steps operations and the secondary flotation reagents employed in these operations may therefore be selected accordingly. Such further froth flotation operations may include, but are not limited to, so-called cleaning and/or scavenging operations.

The recovery step may eventually render a final concentrate product and a final tailings product.

The method may also, optionally, include one or more secondary conditioning steps in which further quantities of the primary reactants are admixed with material that is to be employed as pulp in a particular froth flotation recovery operation. Preferably, when employed, such secondary conditioning steps may be employed ahead of the separate refining steps, typically ahead of each refining step.

While not limiting the invention to this application, and as has been alluded to, it is expected that the invention would find particular application in flotation recovery of platinum group metals as the desired metal content of the desired metal value. More particularly, it is expected that the invention will find particular application in relation to platinum group metals that are in the form of amphoteric minerals in the feedstock material, the mineral form being the desired metal value. It is therefore provided that the desired metal of the desired metal value may be a platinum group metal. It is also provided that the desired metal value may be in the form of an amphoteric mineral of the desired metal. Applicability of the invention in recovering other types of metal values, particularly when occurring as amphoteric minerals, is also expected, however.

IN ACCORDANCE WITH ANOTHER ASPECT OF THE INVENTION, there is provided a process to recover, by means of froth flotation, a desired metal value, containing a desired metal, from a feedstock material containing the desired metal value, the method including
a comminution stage, in which the feedstock material is, in use, comminuted using comminuting media of an iron and chrome steel alloy comprising from 12% to 30% chrome;
a conditioning stage, in which the feedstock material is conditioned for froth flotation recovery of the desired metal value by contacting the feedstock material with thiourea and/or oxalic acid as primary flotation reagent/s,
   wherein the conditioning stage comprises
the comminution stage, with a first quantity of primary flotation reagent/s being added to the feedstock material prior to or in the comminution stage and with preconditioned comminuted feedstock material being obtained from the comminution stage, in use; and
an optional conditioning finishing stage, in which a mixture of the preconditioned comminuted feedstock material and a liquid is subjected to stirring, in use, with a second quantity of the primary flotation reagent/s optionally being added to the preconditioned comminuted feedstock material prior to or in the finishing stage and with conditioned comminuted feedstock material being obtained from the finishing stage, in use,
   the process further including
a recovery stage, in which at least some of the desired metal value is recovered by means of froth flotation from the preconditioned comminuted feedstock or, when the finishing step is conducted, from the conditioned comminuted feedstock to a floated froth product, or concentrate.

The process may, in particular, be a process to implement, in use, a method as hereinbefore described and the features of the process described above may therefore be arranged in a manner for the method steps to be implemented. The process may also include additional features and stages for additional features and steps of the method to be implemented. More particularly, the process may include a separate stage for each of the method steps.

### BRIEF DESCRIPTION OF THE DRAWINGS

THE INVENTION WILL NOW BE DESCRIBED IN MORE DETAIL, with reference to the accompanying drawings.

In the drawings,

FIG. 1 shows, diagrammatically, one embodiment of a process in accordance with the invention; and

FIG. 2 shows, diagrammatically, another embodiment of a process in accordance with the invention.

### DETAILED DESCRIPTION OF THE INVENTION

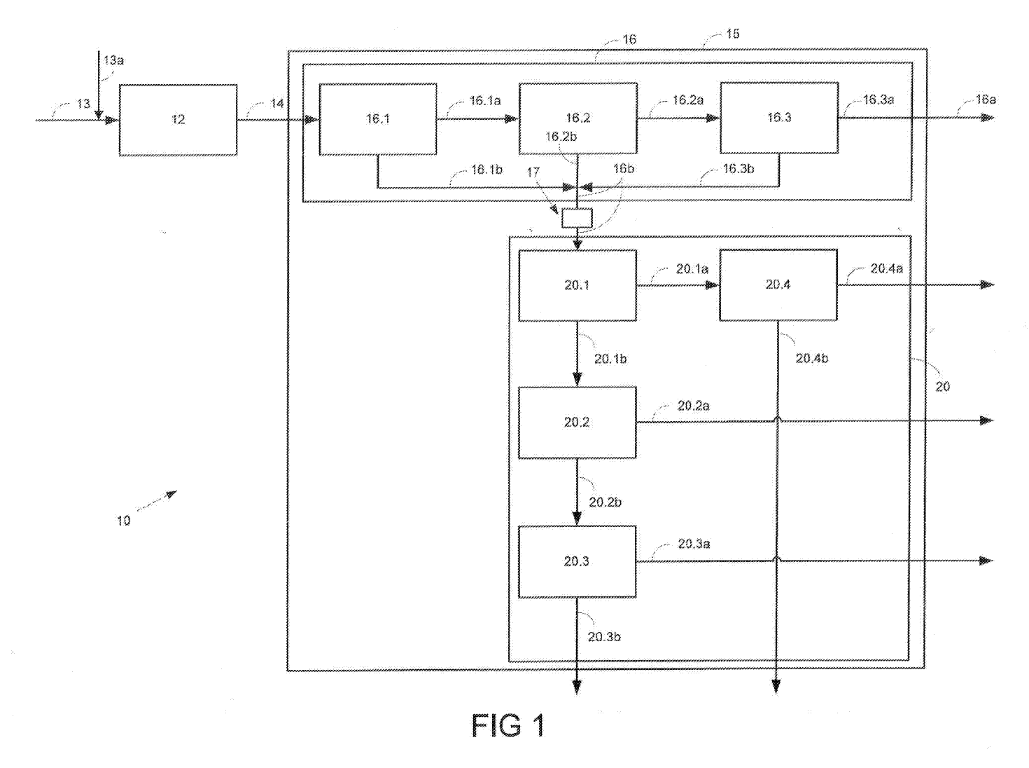

REFERRING TO FIG. 1, reference numeral 10 generally indicates one, non-limiting, embodiment of a process in accordance with the invention to recover, by means of froth flotation, a desired metal value, containing a desired metal, from a feedstock material containing the desired metal value. The process 10, as illustrated, was used in implementing a non-limiting experimental trial of the method of the invention as is described hereinafter.

The process 10 comprises a comminution or milling stage 12. The milling stage 12 comprises a mill. The mill operates with high chrome stainless steel grinding media of an iron and chrome steel alloy comprising from 12% to 30%, typically from 14%, more preferably from 16%, to 18% chrome by mass. Most preferably, the grinding media is of an iron and chrome steel alloy comprising 14%, 16% or 18% chrome by mass.

A feedstock material feed line 13 leads into the milling stage 12 for feedstock material containing the desired metal value to be fed to the milling stage 12 in use. The desired metal value is typically an amphoteric mineral containing a PGM as the desired metal.

A primary flotation reagent feed line 13a, along which primary flotation reagent/s can be introduced into the feedstock material, leads into the feed line 13.

From the milling stage 12, a milled feedstock transfer line 14 leads to a recovery stage 15 which comprises a froth flotation circuit in which a number of froth flotation operations, as hereinafter described, can be carried out for recovery of desired metal value-containing particles to respective floated froth products, or concentrates, thereof to report to a final desired metal value-rich concentrate.

The froth flotation circuit of the recovery stage 15 includes a roughing stage 16 which comprises three roughers 16.1, 16.2, 16.3. As is well known and understood in the art of the invention, roughers, in the context of froth flotation, are agitated froth flotation vessels in which froth flotation operations are carried out to recover desired metal value-containing particles to a low quality floated froth product, or concentrate which is low in quality in that it contains a relatively high proportion of gangue relative to desired metal value-containing particles.

The roughers 16.1, 16.2, 16.3 (hereinafter described respectively as ‘first’, ‘second’ and ‘third’ roughers of the process 10) are arranged to operate in series for series transfer of their tailings. A first rougher tailings transfer line 16.1a leads between the first and second roughers 16.1, 16.2, and a second rougher tailings transfer line 16.2a leads between the second and third roughers 16.2, 16.3. A third rougher tailings transfer line 16.3a leads from the third rougher 16.3 and feeds a roughing stage tailings discharge line 16a. Respective first, second and third rougher concentrate transfer lines 16.1b, 16.2b, 16.3b also lead from the respective roughers 16.1, 16.2, 16.3, but do so in parallel to feed a roughing stage concentrate discharge line 16b. The transfer lines 16.1b, 16.2b, 16.3b serve respectively to transfer to the discharge line 16b a high grade concentrate, a medium grade concentrate and a low grade concentrate, obtained in the manner hereinafter described, from the respective roughers 16.1, 16.2, 16.3

The roughing stage concentrate discharge line 16b, being fed by the rougher concentrate transfer lines 16.1b, 16.2b, 16.3b, is arranged to discharge a combined concentrate stream to a roughing stage concentrate refining, or cleaning, stage 20, serving to implement refining steps in accordance with the method of the invention, which is also included in the flotation circuit 15, first passing through an optional secondary conditioning stage 17 in which an additional quantity of primary flotation reagent/s can be admixed under agitation for a predetermined secondary conditioning time period.

The cleaning stage 20 comprises a cleaner 20.1, a re-cleaner 20.2, a re-re-cleaner 20.3 and a scavenger 20.4.

The rougher stage concentrate transfer line 18 leads into the cleaner 20.1. As is also well known and understood in the art of the invention, cleaners, re-cleaners, re-re-cleaners and scavengers are, similarly to roughers, agitated froth flotation vessels in which respective froth flotation operations can be carried out. In contrast to the froth flotation operations carried out in roughers, however, the froth flotation operations carried out in cleaners, re-cleaners and re-re-cleaners are carried out to produce a higher quality concentrate than roughers, these operations being carried out to reject a higher proportion of gangue when recovering respective cleaner, re-cleaner and re-re-cleaner concentrates. The froth flotation operation carried out in a scavenger is carried out to recover from rougher/cleaner tailings at least some of any particles containing the desired metal value that were not selected to the rougher or cleaner concentrates.

From the cleaner 20.1 a cleaner tailings transfer line 20.1a leads to the scavenger 20.4 and a cleaner concentrate transfer line 20.1b leads to the re-cleaner 20.2.

From the re-cleaner 20.2 leads a re-cleaner tailings discharge line 20.2a and a re-cleaner concentrate transfer line 20.2b. The re-cleaner concentrate transfer line 20.2b leads into the re-re-cleaner 20.3.

From the re-re-cleaner 20.3 leads a re-re-cleaner tailings discharge line 20.3a and a re-re-cleaner concentrate discharge line 20.3b.

Finally, from the scavenger 20.4 leads a scavenger tailings discharge line 20.4a and a scavenger concentrate discharge line 20.4b.

It will be appreciated that the flotation circuit of the recovery stage 15 is an open-circuit, with tailings discharged in use along discharge lines 16a, 20.2a, 20.3a and 20.4a reporting to a final tailings product and concentrates discharged in use along discharge lines 20.3b and 20.4b reporting to a final concentrate product.

In use, feedstock material comprising a desired metal value, which contains a desired metal, typically being mined ore containing amphoteric minerals, as the desired metal value, comprising platinum group metals (PGMs) as the desired metal, is fed to the milling stage 12 along feed line 13 and is then milled in the milling stage 12 to obtain a desired particle size fraction for further treatment, such a fraction desirably being 75 micron in the context of the present invention, preferably having a mean particle size of 75 micron. The particle size fraction to be used in the recovery step could, however, in other embodiments have a mean particle size of between about 53 micron and about 150 micron and milling may therefore be carried out accordingly. Milling is typically effected in aqueous medium, with the feedstock material being milled as a slurry, preferably having a solids content of 75%. Importantly, dosing of primary flotation reagent/s thiourea and/or oxalic acid would, in accordance with the invention, occur along the line 13a, or alternatively directly into the milling stage 12, with milling therefore being effected in the presence of the primary flotation reagent/s. It will be appreciated that the milling stage 12 therefore provides a preconditioning stage implementing preconditioning of the feedstock material in a conditioning step in accordance with the method of the invention. Take note that the embodiment of the invention that is illustrated in FIG. 1, and that is presently being discussed, does not include the optional conditioning finishing step of the invention and that the milling step therefore provides the whole of the conditioning step. Also take note, with reference to the exemplified quantification that follows, that the milling step is effected for a significantly longer period than that which is suggested as preferred in accordance with the preferred embodiments of the invention, while still within the broad scope of the invention. Milling in the exemplified embodiment was, however, overemphasised for the purposes of proof of concept in the exemplified embodiment and to achieve the desired particle size fraction under laboratory conditions.

The slurry, comprising the milled feedstock material and the primary flotation reagent/s, is then fed to the recovery stage 15, and more particularly to the roughing stage 16 thereof, along the milled feedstock transfer line 14. Although not illustrated as such, the milled feedstock material would typically be subjected to particle size classification ahead of the recovery stage 15, with oversized particles preferably being returned to the milling stage 12.

In the roughers 16.1, 16.2, 16.3 of the roughing stage 16, desired metal value-containing particles are recovered, through froth flotation, to respective floated froth products, or rougher concentrates. To this effect, secondary flotation reagents are added to the pulps of the respective roughers 16.1, 16.2, 16.3, as exemplified below. Flotation operations implemented by the respective roughers 16.1, 16.2, 16.3 differ in that they are carried out respectively to recover decreasing grades of desired metal value-containing particles. More particularly, the first rougher 16.1 is operated to recover high grade, fast floating desired metal value-containing particles, the second rougher 16.2 is operated to recover medium grade, slower floating desired metal value-containing particles, and the third rougher 16.3 is operated to recover low grade, even slower floating desired metal value-containing particles. The first rougher 16.1 can therefore be said to implement a high grade recovery step, the rougher 16.2 a medium grade recovery step, and the rougher 16.3 a low grade recovery step. These differences are reflected in progressively increasing pulp residence times in the respective roughers 16.1, 16.2, 16.3, as exemplified below, these residence times being, respectively, a high grade recovery step residence time, a medium grade recovery step residence time and a low grade recovery step residence time. In conducting the respective flotation operations in the respective roughers 16.1, 16.2, 16.3, the tailings of the roughers 16.1, 16.2, 16.3 are passed in series along the rougher tailings transfer lines 16.1a, 16.2a to provide the pulp of the following rougher, and final rougher stage tailings are eventually discharged from the rougher stage 16 along the rougher stage tailings discharge line 16a, being fed by transfer line 16.3a.

The concentrates that are recovered in the respective roughers 16.1, 16.2, 16.3, respectively being high grade, medium grade and low grade concentrates, are fed along concentrate transfer lines 16.1b, 16.2b, 16.3b to roughing stage concentrate discharge line 16b, along which a combined concentrate stream is fed to the cleaning stage 20 in which the combined concentrate is subjected to further froth flotation operations to recover higher quality concentrates, finally to recover a final concentrate product of a high quality in that it contains a desirably high proportion of the desired metal value and a desirably low proportion of gangue. Optionally, before being passed to the cleaning stage 20, the combined concentrate stream is subjected to secondary conditioning in the secondary conditioning stage 17.

In the cleaning stage 20, the combined concentrate is subjected to a further flotation operation in the cleaner 20.1, the concentrate of which is subjected to yet another froth flotation operation in the re-cleaner 20.2, the concentrate of which is subjected to yet a further, and final, froth flotation operation in the re-re-cleaner 20.3. All of these froth flotation operations are carried out for recovery of the desired metal value-containing particles to their respective concentrates. Tailings from the cleaner stage 20 are also subjected to another froth flotation operation in the scavenger 20.4 to recover therefrom at least some of any desired metal value that may not have reported to the concentrate of the cleaner 20.1. The concentrate from the cleaner 20.1 is transferred to the re-cleaner 20.2 along concentrate transfer line 20.1b; the concentrate from the re-cleaner 20.2 is transferred to the re-re-cleaner 20.3 along concentrate transfer line 20.2b; and the concentrate of the re-re-cleaner 20.3 is then discharged as a final cleaning stage concentrate along concentrate discharge line 20.3b to report to a final concentrate product. Tailings from the re-cleaner 20.2 and re-re-cleaner, 20.3 are discharged from these stages 20.2, 20.3 respectively along tailings discharge lines 20.2, 20.3 to report to the final tailings product. Tailings from cleaner 20.1 are transferred to the scavenger stage 20.4 along transfer line 20.1a, with tailings from the scavenger 20.4 then being discharged from the scavenger 20.4 along tailings discharge line 20.4a to report to the final tailings product, and with concentrate from the scavenger stage 20.4 being discharged from the scavenger 20.4 along concentrate discharge line 20.4b to report to the final concentrate product.

In an experimental trial conducted using the process 10 in a batch configuration, 2 kilograms of platinum group metal (PGM)-rich ore from the Platreef deposit in South Africa, containing PGMs the majority of which is present as amphoteric minerals, was milled, in slurry format, in the milling stage 20 for 90 minutes at a 65% solids concentration with high chrome grinding media, the chrome content of which is in a range from 12% to 30%, typically from 14%, more preferably from 16%, to 18% chrome by mass. Most preferably, the grinding media is of an iron and chrome steel alloy comprising 14%, 16% or 18% chrome by mass. Oxalic acid and thiourea primary flotation reagents were added to the mill in the quantities indicated in Table 2 below. Records were then taken of eH and pH measurements, being recorded together with rotor speed. A flotation process was then effected in the flotation circuit of the recovery stage 15 in the manner hereinbefore described in order to recover amphoteric PGM-containing particles from the feedstock material. Feedstock material residence times in the respective roughers, cleaners and scavenger were as is indicated in Table 1 and reagents were added in a stage-wise fashion in the quantities indicated in Table 2 below. Locked cycle tests were also conducted with all tailings discharges reporting to final tailings.

TABLE 1
Flotation Circuit Residence Times

| Flotation circuit stage/component | Flotation residence time (minutes) |
|---|---|
| Rougher 16.1 (High grade) | 5 |
| Rougher 16.2 (Medium grade) | 10 |
| Rougher 16.3 (Low grade) | 15 |
| Cleaner 20.1 | 5 |
| Re-cleaner 20.2 | 4 |
| Re-re-cleaner 20.3 | 4 |
| Scavenger 20.4 | 3 |

It will be appreciated that the pulp residence times in the first, second and third roughers 16.1, 16.2, 16.3 differ markedly, these respectively being high grade, medium grade and low grade recovery step residence times and being reflective of the respective high grade, medium grade and low grade recovery steps that are carried out these roughers 16.1, 16.2, 16.3.

TABLE 2
Reagent addition, residence and operating times, and pH and eH measurements in the
process 10

| | Reagents added, grams per tonne | | | | | | | | | | | |
|---|---|---|---|---|---|---|---|---|---|---|---|---|
| | | | | Oxalic | | | | Time, minutes | | | | Eh |
| Stage | SIPX | 3477 | HP700 | Acid | Thiourea | CMC | — | Grind | Cond. | Froth | pH | (mV) |
| Milling | — | — | — | 200 | 50 | — | — | 90 | | — | 8.8 | +140 |
| 12 | | | | | | | | | | | | |
| Rougher | 25 | 25 | 35 | — | — | — | — | — | 1 | 5 | 8.8 | +80 |
| 16.1 | | | | | | | | | | | | |
| Rougher | 25 | 25 | 10 | — | — | — | — | — | 1 | 10 | 8.7 | +70 |
| 16.2 | | | | | | | | | | | | |
| Rougher | 25 | 25 | 10 | — | — | — | — | — | 1 | 15 | 8.6 | +70 |
| 16.3 | | | | | | | | | | | | |
| Conditioner | — | — | — | 80 | 20 | — | — | — | 2 | — | 8.0 | +120 |
| 17 | | | | | | | | | | | | |
| Cleaner | 10 | 10 | 5 | — | — | 50 | — | — | 1 | 5 | 8.2 | +100 |
| 20.1 | | | | | | | | | | | | |
| Scavenger | 2.5 | 2.5 | 5 | — | — | — | — | — | 1 | 3 | 8.2 | +100 |
| 20.4 | | | | | | | | | | | | |
| Re-cleaner | 2.5 | 2.5 | 5 | — | — | 25 | — | — | 1 | 4 | 8.2 | +100 |
| 20.2 | | | | | | | | | | | | |
| Re-re-cleaner | 2.5 | 2.5 | 7.5 | — | — | 10 | — | — | 1 | 4 | 8.0 | +120 |
| 20.3 | | | | | | | | | | | | |
| Total | 93 | 93 | 78 | 280.0 | 70 | 85 | — | — | — | — | — | — |

The ‘Froth’ column in the Table 2 indicates the applicable pulp residence times in the particular froth flotation operations.

In the milling stage 12, grinding and conditioning occur simultaneously and therefore the 90 minute milling time is indicated across both the ‘Grind’ and ‘Cond’ columns, with ‘Cond’ of course designating ‘Conditioning’.

It will be appreciated that SIPX, 3477, HP700 and CMC are secondary flotation reagents.

It will further be noted, from the ‘Cond’ column, that ‘conditioning’ also occurs in the froth flotation operations. This ‘conditioning’ is, however, carried out to disperse secondary flotation reactants in the pulp of these froth flotation operations and is therefore not conditioning in the sense of the invention. During such conditioning, no gas is passed through the particular flotation vessel, with the pulp merely being stirred for the indicated period in the presence of the secondary reagents as indicated.

A relationship was found to exist between Eh (Oxygen Reduction Potential) and grinding media type. Previous test work was conducted with carbon steel media, high nickel stainless steel media (Ni SS media) and high chrome media. With the change from carbon steel media to high chrome stainless steel media and Ni SS media, a positive reduction potential was noted, where it was previously negative when using carbon steel media. Grinding media was therefore identified as an important factor in improving both grade and recovery.

The use of the above-outlined reagents and specific grinding media produced what is regarded as a saleable concentrate grade at acceptable recoveries for Platreef ore in particular. The recoveries achieved in this experimental trial are presented in Table 3 below.

TABLE 3
Experimental recoveries achieved

| | g/t PGE | Recovery (%) |
|---|---|---|
| Cleaner 20.3 | 143.17 | 77.26 |
| concentrate | | |
| Cleaner 20.2 | 131.88 | 80.53 |
| concentrate | | |
| Cleaner 20.1 | 58.39 | 82.65 |
| concentrate | | |
| Rougher stage | 24.11 | 91.25 |
| 16 concentrate | | |
| Scavenger 20.4 | 7.89 | 3.59 |
| concentrate | | |
| Scavenger 20.4 | 2.62 | 5.02 |
| tailings | | |
| Rougher stage | 0.45 | 8.75 |
| 16 tailings | | |
| Head (calc.) | 4.27 | 100 |

The Applicant found that the use of the thiourea and oxalic acid reagents and high chrome grinding media markedly improve the floatability of PGM amphoteric minerals and lead to a marked increase in recovery of these minerals, as desired metal value-containing particles, over that which has been observed in cases in which thiourea and oxalic acid are not used. Advantageously, this effect was achieved with a relatively and economically attractive coarse particle size fraction of 75 micron, in comparison to the typically small grain size (<8 micron) of PGMs in the amphoteric minerals. This is regarded as being significant in the context of the difficulties that the invention seeks to address, suggesting that milling time can be minimized and particle size can be maximized to economically attractive levels while achieving acceptable desired metal value recoveries. The Applicant also surprisingly, and importantly, found that mere addition of thiourea and oxalic acid to a froth flotation operation is not effective in realising this effect. Mere admixing of thiourea and oxalic acid with the feedstock was also found to be of little advantage. Carrying out the conditioning step in the manner set forth by the present invention, particularly by introducing thiourea and oxalic acid into the milling stage and carrying out conditioning for the conditioning period as set forth by the invention was therefore found to be an important feature of the invention that allows the advantage of improved PGM amphoteric floatability using thiourea and oxalic acid to be realised.

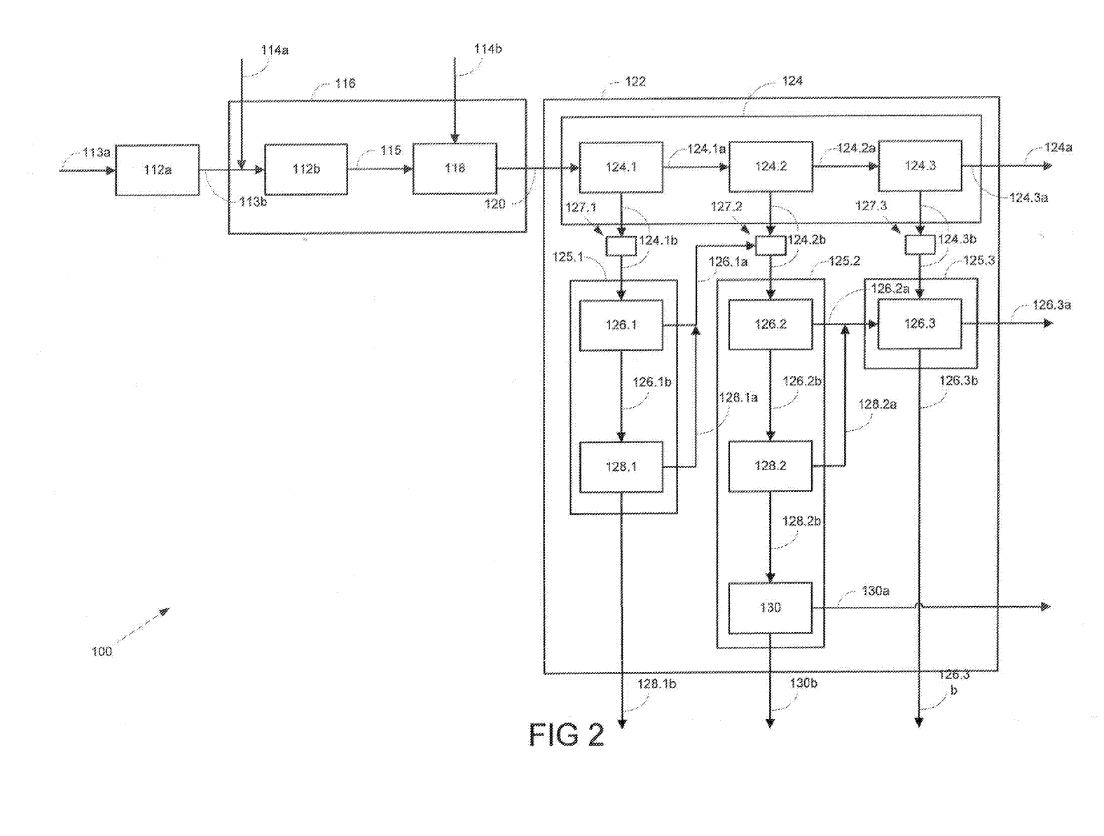

REFERENCE IS NOW MADE TO FIG. 2 in which reference numeral 100 generally indicates another non-limiting embodiment of a process in accordance with the invention to recover, by means of froth flotation, a desired metal value from a feedstock material containing the desired metal value. The process 100, as illustrated, was used in implementing an experimental trial of the method of the invention as is described hereinafter.

The process 100 agrees in many respects with the process 10 of FIG. 1, but has some important differences which will be evident from the description that follows.

The process 100 comprises an optional first, or pre-, comminution or milling stage 112a, required for experimental purposes and due to laboratory constraints. The first milling stage 112a comprises a mill. The mill operates with high chrome stainless steel grinding media, being of an iron and chrome steel alloy comprising from 12% to 30%, typically from 14%, more preferably from 16%, to 18% chrome. Most preferably, the grinding media is of an iron and chrome steel alloy comprising 14%, 16% or 18% chrome by mass. The process 100 also comprises a second comminution or milling stage 112b, also comprising a mill that operates with high chrome stainless steel media of the type described above. While the first milling stage 112a is being illustrated and discussed, it is to be noted that it would most likely not be employed in an upscaled embodiment of the process 100.

A feedstock material feed line 113a leads into the first milling stage 112a for feedstock material, which contains the desired metal value, to be fed to the first milling stage 112a in use. From the first milling stage 112a, a pre-milled feedstock transfer line 113b leads to the second milling stage 112b. A first primary flotation reagent feed line 114a feeds into the pre-milled feedstock material transfer line 113b. Primary flotation reagent/s, as hereinbefore described, can be introduced, in use, along the feed line 114a into a pre-milled feedstock material stream that is being transferred to the second milling stage 112b so that milling in the second milling stage 112b can be effected in the presence of the primary flotation reagent/s to provide preconditioned milled feedstock material. In such a case, the second milling stage 112b would therefore form part of a conditioning stage and implement a preconditioning step in accordance with the invention. The conditioning stage is generally indicated in FIG. 2 by reference numeral 116.

The process 100 also includes, as part of the conditioning stage 116, a conditioning finishing stage 118 in accordance with the process of the invention. The conditioning finishing stage 118 serves to implement a conditioning finishing step in accordance with the method of the invention. The conditioning finishing stage 118 comprises a vessel provided with agitating, or stirring, means and is fed, in use, with preconditioned milled feedstock material along a preconditioned milled feedstock material transfer line 115 which leads from the second milling stage 112b to the conditioning finishing stage 118. An optional, but not preferred, primary flotation reagent feed line 114b also leads into the conditioning finishing stage 118, along which additional primary flotation reagent/s can, in use, be fed to the conditioning finishing stage 118.

A conditioned feedstock material transfer line 120, along which conditioned feedstock material produced from the conditioning finishing stage 118 can, in use, be withdrawn from the conditioning finishing stage 118, leads from the conditioning finishing stage 118.

The process 100 further includes a recovery stage 122 which serves to implement a recovery step of the method of the invention. As in the case of the process 10, the recovery stage 122 of the process 100 comprises a flotation circuit which serves, in use, to implement froth flotation operations to effect froth flotation recovery of the desired metal value, more particularly of particles containing the desired metal value contained in the feedstock material.

Optionally, but preferably, the process 100 includes a particle size classification stage (not illustrated) ahead of the recovery stage 122 serving to recover, from the conditioned feedstock material, a particle size fraction of particles of desired particle size for use in the recovery stage 122 and to return oversize particles to the first and/or second milling stages 112a, 112b. In the case of the present invention, the preferred particle size fraction for use in the recovery stage 122 is 75 micron.

The flotation circuit of the recovery stage 122 includes a roughing stage 124 which comprises three roughers 124.1, 124.2, 124.3 serving to carry out, in use, roughing froth flotation operations. The roughers 124.1, 124.2, 124.3 (hereinafter described respectively as ‘first’, ‘second’ and ‘third’ roughers of the process 100) are arranged to operate in series for series transfer of their tailings. A first rougher tailings transfer line 124.1a leads between the first and second roughers 124.1, 124.2, and a second rougher tailings transfer line 124.2a leads between the second and third roughers 124.2, 124.3. A third rougher tailings transfer line 124.3a leads from the third rougher 124.3 and feeds a roughing stage tailings discharge line 124a. Respective first, second and third rougher concentrate transfer lines 124.1b, 124.2b, 124.3b also lead from the respective roughers 124.1, 124.2, 124.3, but do so in parallel. In each of the transfer lines 124.1b, 124.2b, 124.3b is provided optional secondary conditioning stages 127.1, 127.2, 127.3 in which additional quantities of primary flotation reagent/s can be admixed under agitation for predetermined secondary conditioning time periods.

As with the rougher stage 16 of the process 10, flotation operations implemented by the roughers 124.1, 124.2, 124.3 differ in that they are operated respectively to recover decreasing grades of desired metal value-containing particles. More particularly, the first rougher 124.1 is operated to recover high grade, fast floating desired metal value-containing particles and render a high grade concentrate, the second rougher 124.2 is operated to recover medium grade, slower floating desired metal value-containing particles to render a medium grade concentrate, and the third rougher 124.3 is operated to recover low grade, even slower floating desired metal value-containing particles to render a low grade concentrate. These differences are reflected in differences in pulp residence times in the respective roughers 124.1, 124.2, 124.3, as exemplified below, these respectively comprising a high grade recovery step residence time, a medium grade recovery step residence time and a low grade recovery step residence time. In conducting the respective flotation operations in the respective roughers 124.1, 124.2, 124.3, the tailings of the roughers 124.1, 124.2, 124.3 are passed in series along the rougher tailings transfer lines 124.1a, 124.2a and final rougher stage tailings are eventually discharged along the rougher stage tailings discharge line 124a, being fed by transfer line 124.3a. Secondary flotation reagents in accordance with the invention are also added to the pulps of the respective roughers 124.1, 124.2, 124.3 to effect the desired froth flotation, as exemplified below.

In contrast to the rougher stage 15 of the process 10 of FIG. 1, the first, second and third rougher concentrate transfer lines 124.1b, 124.2b, 124.3b do not feed a single rougher stage concentrate discharge line, such as the discharge line 16b of the process 10, which, in turn, feeds a single cleaning/scavenging stage, such as the stage 20 of the process 10. Instead, the transfer lines 124.1b, 124.2b, 124.3b lead, respectively, to respective first, second and third refining, or cleaning, stages 125.1, 125.2, 125.3, respectively being associated with and providing for refining, or cleaning, the concentrates of the first, second and third rougher stages 124.1, 124.2, 124.3. As in the case of the process 10, ‘cleaning’ means reducing the quantity of gangue that report to the final concentrate product and obtaining a higher quality concentrate insofar desired metal value concentrate is concerned.

More particularly, the first cleaning stage 125.1 comprises a first cleaner 126.1 and a first re-cleaner 128.1. The first rougher concentrate transfer line 124.1b leads to the first cleaner 126.1. A first cleaner concentrate transfer line 126.1b leads from the first cleaner 126.1 to the first re-cleaner 128.1 and a first final concentrate discharge line 128.1b leads from the re-cleaner 128.1. A first cleaner tailings transfer line 126.1a leads from the first cleaner 126.1, while a first re-cleaner tailings transfer line 128.1a leads from the first re-cleaner 128.1. The first re-cleaner tailings transfer line 128.1a leads into the first cleaner tailings transfer line 126.1a.

The second cleaning stage 125.2 comprises a second cleaner 126.2, a second re-cleaner 128.2 and a re-re-cleaner 130. The second rougher concentrate transfer line 124.2b leads to the second cleaner. The first cleaner tailings transfer line 126.1a, into which the first re-cleaner tailings transfer line 128.1a feeds, feeds into the second concentrate transfer line 124.2b, upstream of the second cleaner 126.2. When the optional secondary conditioning stage 127.2 is employed, as illustrated, the transfer line 126.1a feeds into the stage 127.2. A second cleaner concentrate transfer line 126.2b leads from the second cleaner 126.2 to the second re-cleaner 128.2 and a second re-cleaner concentrate transfer line 128.2b leads to the re-re-cleaner 130, with a second final concentrate discharge line 130b leading from the re-cleaner 130. A second cleaner tailings transfer line 126.2a leads from the second cleaner 126.2, a second re-cleaner tailings transfer line 128.2 leads from the second re-cleaner 128.2 and a first final tailings discharge line 130a leads from the re-re-cleaner. The second re-cleaner tailings transfer line 128.2a feeds into the second cleaner tailings transfer line 126.2a.

The third cleaning stage 125.3 comprises only a third cleaner 126.3 into which the third rougher concentrate transfer line 124.3b leads, as well as the second cleaner tailings transfer line 126.2a. From the third cleaner 126.3 leads a third final tailings discharge line 126.3a and a third final concentrate discharge line 126.3b.

In use, feedstock material containing the desired metal value, typically being an amphoteric mineral containing a PGM as the desired metal, is fed to the first, optional milling stage 112a along feed line 113a. In the first milling stage 112a the feedstock is subjected to pre-milling, preferably in aqueous medium as a slurry, typically at a solids concentration of 75%.

The pre-milled feedstock is then passed from the first milling stage 112a to the second milling stage 112b along transfer line 113b, with primary flotation reactant/s thiourea and/or oxalic acid being introduced into the pre-milled feedstock along first primary reactant feed line 114a before the pre-milled feedstock is fed to the second milling stage 112b.

In the second milling stage 112b, the pre-milled feedstock is subjected to further milling for a predetermined milling, or comminution, period. This milling period is, in accordance with the invention, preferably between 5 and 15 minutes in length. Preferably, milling in the second milling stage 112b is effected to obtain a desired particle size fraction of 75 micron, preferably having a mean particle size of 75 micron, to be used in the recovery stage 122. The particle size fraction to be used in the recovery step could, however, in other embodiments have a mean particle size of between about 53 micron and about 150 micron and milling may therefore be carried out accordingly. At the same time, the feedstock becomes preconditioned with the primary flotation reagents through intimate contact therewith in the mill.

Preconditioned milled feedstock is then passed along transfer line 115 to the conditioning finishing stage 118, in which the feedstock is mixed as a mixture in the presence of a liquid, preferably water, for a predetermined conditioning finishing period. This conditioning finishing period is, in accordance with the invention, preferably between 30 and 60 minutes in length. Optionally, but not preferably, additional quantities of the primary flotation reagent/s are added to the preconditioned feedstock along feed line 114b in and/or upstream of the conditioning finishing stage 118. Preferably, the solids concentration of the preconditioned milled feedstock and water mixture is 60%, with dilution being effected, if necessary, to achieve this.

Conditioned milled feedstock is then passed from the conditioning finishing stage 118 to the recovery stage 122, more particularly to the rougher stage 124, specifically to the first rougher 124.1 in the rougher stage 124.

In the first rougher stage 124.1, a first rougher froth flotation operation is effected for a predetermined first rougher froth flotation period to recover some desired metal value-containing particles from the conditioned milled feedstock and obtain first rougher floated froth product, or first rougher concentrate, and first rougher tailings. Preferably, the first froth flotation operation is effected in such a manner as to recover high grade particles to the first rougher concentrate. It will be appreciated that, in this context, the first rougher 124.1 implements a high grade recovery step.

The first rougher tailings are then passed to the second rougher 124.2 along transfer line 124.1a, in which the first rougher tailings are subjected to a second rougher froth flotation operation for a predetermined second rougher flotation period to recover some more desired metal value-containing particles from the first rougher tailings and obtain second rougher floated froth product, or second rougher concentrate, and second rougher tailings. Preferably, the second rougher froth flotation operation is effected in such a manner as to recover medium grade particles to the second rougher concentrate. It will be appreciated that, in this context, the second rougher 124.2 implements a medium grade recovery step.

The second rougher tailings are then passed to the third rougher 124.3 along transfer line 124.2a, in which the second rougher tailings is subjected to a third rougher froth flotation operation for a predetermined third rougher froth flotation period to recover yet some more desired metal value-containing particles from the first rougher tailings and obtain third rougher floated froth product, or third rougher concentrate, and third rougher tailings. Preferably, the third rougher froth flotation operation is effected in such a manner as to recover low grade particles to the third rougher concentrate. It will be appreciated that, in this context, the third rougher 124.1 implements a low grade recovery step.

The third rougher tailings are discharged from the third rougher along transfer line 124.2a to feed discharge line 124a to leave the rougher stage 124 as a first final tailings product. The first, second and third rougher concentrates are, in contrast to the process 10, not combined for cleaning and scavenging, but are passed respectively along transfer lines 124.1b, 124.2b and 124.2c to their associated cleaning stages 125.1, 125.2, 125.3.

The first rougher concentrate is, more particularly, passed along transfer line 124.1b to the first cleaner 126.1, optionally being subjected to secondary conditioning in the stage 127.1. In the first cleaner 126.1 the first rougher concentrate is subjected to a first cleaning froth flotation operation, rejecting for selection to the a first cleaner concentrate at least some gangue contained in it, thereby to obtain first cleaner concentrate and first cleaner tailings. The first cleaner tailings are withdrawn from the first cleaner 126.1 along transfer line 126.1a and the first cleaner concentrate is withdrawn from the first cleaner along transfer line 126.1b. The first cleaner tailings are passed along transfer line 126.1a to transfer line 124.2b to be combined with the second rougher concentrate. The first cleaner concentrate is passed along transfer line 126.1b to the first re-cleaner 128.1. In the first re-cleaner 128.1, the first cleaner concentrate is subjected to a first re-cleaner froth flotation operation, rejecting for selection a first re-cleaner concentrate further gangue contained in it, thereby to obtain first re-cleaner concentrate and first re-cleaner tailings. The first re-cleaner concentrate is discharged from the first re-cleaner 128.1 along discharge line 128.1b as the first final concentrate product. The first re-cleaner tailings are passed along transfer line 128.1a and are fed to transfer line 126.1a to be combined with second rougher concentrate, along with the first cleaner tailings.

The second rougher concentrate, along with the first cleaner tailings and the first re-cleaner tailings, is passed along transfer line 124.2b to the second cleaner 126.2, optionally being subjected to secondary conditioning in the stage 127.2. In the second cleaner 126.1 the second rougher concentrate, along with the first cleaner tailings and the first re-cleaner tailings, is subjected to a second cleaning froth flotation operation, rejecting for selection to a second cleaner concentrate at least some gangue, thereby to obtain second cleaner concentrate and second cleaner tailings. The second cleaner tailings are withdrawn from the second cleaner 126.2 along transfer line 126.2a and the second cleaner concentrate is withdrawn from the second cleaner along transfer line 126.2b. The second cleaner tailings are passed along transfer line 126.2a to the third cleaner 126.3. The second cleaner concentrate is passed along transfer line 126.2b to the second re-cleaner 128.2. In the second re-cleaner 128.2, the second cleaner concentrate is subjected to a second cleaner froth flotation operation, rejecting for selection to a second re-cleaner concentrate further gangue, thereby to obtain second re-cleaner concentrate and second re-cleaner tailings. The second re-cleaner tailings are passed along transfer line 128.2a and are fed to transfer line 126.2a to be combined with first cleaner tailings and to be fed to the third cleaner along with it. The second re-cleaner concentrate is passed from the second re-cleaner 128.2 along transfer line 128.2b to the first re-re-cleaning stage 130 in which it is subjected to a re-re-cleaning froth flotation operation, rejecting for selection to a re-re-cleaner concentrate further undesired minerals, thereby to obtain re-re-cleaner concentrate along discharge line 130b as the second final concentrate product and re-re-cleaner tailings along discharge line 130a as the second final tailings product.

The third rougher concentrate is passed along transfer line 124.3b to the third cleaner 126.3, optionally being subjected to secondary conditioning in the stage 127.1. In the third cleaner 126.3 the third rougher concentrate is, along with the second cleaner tailings and the second re-cleaner tailings, subjected to a third cleaning froth flotation operation, rejecting for selection to a third cleaner concentrate at least some gangue contained in it, thereby to obtain third cleaner concentrate and third cleaner tailings. The third cleaner tailings are withdrawn from the third cleaner 126.3 along discharge line 126.3a as the third final tailings product. The third cleaner concentrate is withdrawn from the third cleaner along discharge line 126.3b as the third final concentrate product.

The process 100 was used in conducting another experimental trial implementing the method of the invention. In the trial, another 2 kg of ore from the Platreef deposit, containing PGMs the majority of which are present as amphoteric minerals, was subjected to batch treatment in process 100 the manner described above to recover therefrom PGM amphoterics as desired metal value.

The feedstock was milled in the first milling stage 112a to a mean particle size of about 1.7 mm and then in the second milling stage 112b to a mean particle size of about 75 micron. The process 100 then continued in the manner described above with reagent addition and residence times being as represented in Table 4:

TABLE 4
Reagent addition, residence and treatment times in the process 100
Float Conditions

| | Reagents [g/t] (1% solution) | | | | | | | | |
|---|---|---|---|---|---|---|---|---|---|
| | | Aero | Senfroth | Oxalic | | Sendep | Time [min] | | |
| Stage | SIPX | 3477 | 522 | acid | Thiourea | 30E | Mill | Condition | Float |
| Mill 112a | — | — | — | — | — | — | 109 | — | — |
| Mill 112b | — | — | — | 200 | 50 | — | 5 | | — |
| Conditioning Finishing 118 | — | — | — | — | — | — | — | 30 | — |
| Rougher Circuit | | | | | | | | | |
| Rougher 1 124.1 | 25 | 25 | 35 | — | — | — | — | 1 | 3 |
| Rougher 2 124.2 | 25 | 25 | 10 | — | — | — | — | 1 | 10 |
| Rougher 3 124.3 | 25 | 25 | 10 | — | — | — | — | 1 | 17 |
| High Grade Cleaner Circuit | | | | | | | | | |
| 125.1 | | | | | | | | | |
| Secondary conditioner 127.1 | — | — | — | 20 | 5 | — | — | 10 | — |
| High Grade 1st Cleaner 126.1 | 5 | 5 | 7.5 | — | — | 15 | — | 1 | 7 |
| High Grade 2nd Cleaner 128.1 | 2.5 | 2.5 | 5 | — | — | 2.5 | — | 1 | 5 |
| Medium Grade Cleaner | | | | | | | | | |
| Circuit 125.2 | | | | | | | | | |
| Secondary conditioner 127.2 | — | — | — | 30 | 7 | — | — | 10 | — |
| Medium Grade 1st Cleaner | 5 | 5 | 5 | — | — | 50 | — | 1 | 10 |
| 126.2 | | | | | | | | | |
| Medium Grade 2nd Cleaner | 2.5 | 2.5 | 5 | — | — | 15 | — | 1 | 6 |
| 128.2 | | | | | | | | | |
| Medium Grade 3nd Cleaner | — | — | — | — | — | — | — | 1 | 4 |
| 130 | | | | | | | | | |
| Low Grade Cleaner Circuit | | | | | | | | | |
| 125.3 | | | | | | | | | |
| Secondary conditioner 127.3 | — | — | — | 30 | 7 | — | — | 10 | — |
| Low Grade 1st Cleaner 126.3 | 2.5 | 2.5 | 5 | — | — | — | — | 1 | 15 |
| Total | 93 | 93 | 83 | 280 | 69 | 83 | | | |

It will be appreciated from the column entitled ‘Float’ in the section entitled ‘Time [min[’ in the above table, that there are marked differences in the flotation residence times in the roughers 124.1, 124.2 and 124.3. These residence times are, respectively, a high grade recovery step residence time, a medium grade recovery step residence time and a low grade recovery step residence time.

It will further be noted, from the ‘Condition’ (‘conditioning’) column, that ‘conditioning’ also occurs in the froth flotation operations. This ‘conditioning’ is, however, carried out to disperse secondary flotation reactants in the pulp of these froth flotation operations and is therefore not conditioning in the sense of the invention. During such conditioning, no gas is passed through the particular flotation vessel, with the pulp merely being stirred for the indicated period in the presence of the secondary reagents as indicated.

It will further be appreciated that SIPX, Aero 3477, Senfroth 522 and Sendep 30E are secondary flotation reagents. Senfroth 522 is a frother that is obtainable from the company Senfroth. Sendep 30E is a gangue depressant that is also obtainable from the company Senfroth.

The trial achieved a final concentrate PGE (platinum group element) recovery of 82% 4E at a concentrate grade of 109 g/t 4E PGE. This is regarded as a marked improvement over the recovery that is achievable when thiourea and oxalic acid are not used, or are not used along with conditioning in the manner set forth by the present invention, and when using mild steel, or other, grinding media than that which is employed according to the present invention.

The same comments made above in relation to the advantages noted in the first experimental trial apply to the present trial. An additional, important, comment is, however, that with this second trial, the Applicant surprisingly found that comparable advantages can be achieved when applying a shorter milling period during which preconditioning is effected and thereafter subjecting the milled preconditioned feedstock to conditioning finishing in the manner described. This is regarded as particularly advantageous for upscaled applications in which milling time seldom exceeds 5 minutes.

Discussion

THE APPLICANT has found that thiourea and oxalic acid can be employed according to the method of the invention to recover, through froth flotation, economically attractive amounts of PGMs from feedstock materials in which such PGMs are contained in fine grains as amphoteric minerals. In this regard, addition of thiourea and oxalic acid to the milling operation and the employment of the claimed conditioning period, particularly when effecting the conditioning finishing step, are regarded as particularly important features.

The Applicant has also found that by employing high chrome stainless steel grinding media, recovery is even further improved since Eh (reduction potential) becomes positive when using such media, which is advantageous to froth flotation. In cases in which other grinding media were used, a negative reduction potential was observed.

The Applicant therefore the invention as addressing, in an advantageously efficient, effective and economically attractive manner, the difficulties usually associated with amphoteric mineral flotation and were hereinbefore outlined.

1. A method to recover, by means of froth flotation, a desired metal value, containing a desired metal, from a feedstock material containing the desired metal value, the method including
in a comminution step, comminuting the feedstock material using comminuting media of a chrome steel alloy comprising from 12% to 30% chrome;
in a conditioning step, conditioning the feedstock material for froth flotation recovery of the desired metal value by contacting the feedstock material with thiourea and/or oxalic acid as primary flotation reagents,
wherein the conditioning step comprises
the comminution step, with a first quantity of primary flotation reagent/s being added to the feedstock material prior to or during the comminution step and with preconditioned comminuted feedstock material being obtained from the comminution step; and
an optional conditioning finishing step, in which a mixture of the preconditioned comminuted feedstock material and a liquid is subjected to stirring, with a second quantity of the primary flotation reagent/s optionally being added to the preconditioned comminuted feedstock material prior to or during the finishing step and with conditioned comminuted feedstock material being obtained from the conditioning finishing step,
the method further including
in a recovery step, recovering by froth flotation at least some of the desired metal value from the preconditioned comminuted feedstock or, when the finishing step is conducted, from the conditioned comminuted feedstock to a floated froth product, or concentrate.

2. The method according to claim 1, in which the conditioning step is effected for a conditioning period that is from 35 minutes to 75 minutes in length.

3. The method according to claim 2, which includes the conditioning finishing step, in which the comminution step is effected for a comminution period that is from 5 minutes to 15 minutes in length and the finishing step is effected for a finishing period that is from 30 minutes to 60 minutes in length, with both the comminution and finishing periods running concurrently with, and therefore making up, the conditioning period.

4. The method according to claim 1, in which the comminution media comprises from 14% to 18% chrome.

5. The method according to claim 1, in which the feedstock material is comminuted in the comminution step as a slurry such that the preconditioned feedstock material obtained from the comminution step is also a slurry and has a solids concentration of 75%.

6. The method according to claim 1, in which the finishing step is effected and in which the mixture of the preconditioned feedstock and the liquid that is stirred in the finishing step has a solids concentration of 60%.

7. The method according to claim 1, in which both oxalic acid and thiourea are used as primary flotation reagents.

8. The method according to claim 7, in which the first quantity of primary flotation reactants comprises oxalic acid in an amount of 200 grams per tonne of dry feedstock material and thiourea in an amount of 50 grams per tonne of dry feedstock material.

9. The method according to claim 1, in which the feedstock material is comminuted to obtain, for use in the recovery step, a particle size fraction of preconditioned or conditioned feedstock having a mean particle size of between 53 micron and 150 micron, both values included.

10. The method according to claim 1, in which the feedstock material is comminuted to obtain, for use in the recovery step, a 75 micron mean particle size fraction of preconditioned or conditioned feedstock.

11. The method according to claim 10, which includes a classification step ahead of the recovery step in which the preconditioned or conditioned feedstock is subjected to particle size-based classification with a ≦75 micron size fraction being recovered and used in the recovery step and a ≧75 micron size fraction being recovered and, optionally, re-used in the comminution step.

12. The method according to claim 1, in which the recovery step includes
in a high grade recovery step, recovering, as a high grade concentrate, high grade preconditioned or conditioned desired metal value-containing particles;
in a separate and following medium grade recovery step, recovering, as a medium grade concentrate, medium grade preconditioned or conditioned desired metal value-containing particles from tailings from the high grade recovery step; and
in a separate and following low grade recovery step, recovering, as a low grade concentrate, low grade preconditioned or conditioned desired metal value-containing particles from tailings of the medium grade recovery step.

13. The method according to claim 1, in which the desired metal value is an amphoteric mineral containing the desired metal.

14. The method according to claim 1, in which the desired metal is a platinum group metal.

15. The method according to claim 1, in which the second quantity of the primary flotation reagents comprises both oxalic acid and thiourea.

16. A process to recover, by means of froth flotation, a desired metal value, containing a desired metal, from a feedstock material containing the desired metal value, the method including
a comminution stage, in which the feedstock material is, in use, comminuted using comminuting media of a chrome steel alloy comprising from 12% to 30% chrome;
a conditioning stage, in which the feedstock material is conditioned for froth flotation recovery of the desired metal value by contacting the feedstock material with thiourea and/or oxalic acid as primary flotation reagent/s,
wherein the conditioning stage comprises
the comminution stage, with a first quantity of primary flotation reagent/s being added to the feedstock material prior to or in the comminution stage and with preconditioned comminuted feedstock material being obtained from the comminution stage, in use; and
an optional conditioning finishing stage, in which a mixture of the preconditioned comminuted feedstock material and a liquid is subjected to stirring, in use, with a second quantity of the primary flotation reagent/s optionally being added to the preconditioned comminuted feedstock material prior to or in the finishing stage and with conditioned comminuted feedstock material being obtained from the finishing stage, in use,
the process further including
a recovery stage, in which at least some of the desired metal value is recovered by means of froth flotation from the preconditioned comminuted feedstock or, when the finishing step is conducted, from the conditioned comminuted feedstock to a floated froth product, or concentrate.

17. The process according to claim 16, in which the first quantity of the primary flotation reagents comprises both oxalic acid and thiourea.

18. The process according to claim 16, in which the second quantity of the primary flotation reagents comprises both oxalic acid and thiourea.
